(19) United States
(12) Patent Application Publication
(10) Pub. No.: US 2013/0125330 A1
(43) Pub. Date: May 23, 2013

(54) Clear-Site: The Heated Wiper Arm System

(71) Applicant: Charles Edwin King, JR., Sandy Hook, CT (US)

(72) Inventor: Charles Edwin King, JR., Sandy Hook, CT (US)

(21) Appl. No.: 13/300,558

(22) Filed: Nov. 19, 2011

(51) Int. Cl. B60S 1/02

(52) U.S. Cl. 15/250.05

(57) ABSTRACT

This invention relates to a new and useful improvement in a heated wiper arm system which is electrically heated for use on the windshields of vehicles, such as automobiles, trucks, trains, boats, airplanes and the like so as to prevent the accumulation of ice, sleet or snow on the arm of the wiper assembly. More particularly, this invention has references to an improved heating arrangement designed to be used in windshield wiper arm assemblies. A heating element of resistance wire is disposed the entire length of the passageway of The wiper arm system and beyond into the blade carrier. The heating arrangement is connected to the vehicle battery to heat the heating element allowing the entire outer circumference of the entire wiper arm system and blade carrier to melt frozen precipitation on the wiper arm assembly and blade carrier.

### FIELD OF INVENTION

This invention relates generally to a heated wiper arm system unit which-incorporates a heating means for a wiper arm assembly and-wiper blade carrier; and is suitable for incorporating into a newly designed or current wiper blade art.

### BACKGROUND OF INVENTION

When a vehicle is operated during blizzard, snow, sleet, or other inclement conditions, precipitation may not be cleared away because the wiper arm becomes lodged with ice and snow build-up, whereupon the wiper arm pushes away from the windshield because of this build-up. The vehicle defroster is incapable of heating the windshield sufficiently to melt the frozen precipitation forming on the arm, and associated mountings. When this icy build-up occurs the wiping performance is restricted ultimately severely reducing the vision and hazards trying to clear the arm of snow and ice on the vehicle, thereby creating driving hazards which in many instances have resulted in serious accidents.

It has been heretofore proposed that the heated wiper arm system and the blade carrier be heated so as to eliminate the hazards noted above. The main object of the present invention is to provide an improved heating means to a windshield wiper arm and the blade carrier that is particularly designed to be adapted for commercial large-scale production. To this end, it is proposed to provide a heated wiper arm system which will make maximum use of the electrical energy required for heating to make the removal of snow and ice as easy as turning the system on.

The heated wiper arm system and carrier in which the heating arrangement is incorporated must be constructed of heat resistant material so that there is no deterioration of the materials in temperatures of up to 200 degrees Fahrenheit; incorporate an elongated passageway extending through the entire length of the wiper arm and also tubular wiper blade carrier.

The heating arrangement of this invention is inserted within the passageway of the wiper arm under body and to and through the tubular of the blade carrier. A highly effective heated wiper arm system and utilizing applicant's heating element, associated components, and circuitry can create carrier.

There have been a variety of attempt to improve the wiping action of a windshield wiper to clean the outer surface of a windshield in inclement weather.

U.S. Pat. No. 4,497,083 discloses a heated blade having a resistance wire running along the length of the wiper arm, the blade carrier and the wiper blade to heat the blade and carrier when it is connected to a vehicle's electrical system. The path through which the resistance wire travels and it's various connections are quite complex in order to provide a blade which can be replaced independently of the arm and carrier.

U.S. Pat. No. 4,928,345 discloses a rather complex heated windshield wiper blade and holder utilizing more than one heating element. It appears to be quite weighty, thereby creating stress and excessive wear on the linkage and wiper motor.

U.S. Pat. No. 4,152,808 discloses a heating element of 0.125 inch wide and 0.005 inch thick embedded in the sides of a frame adapted to receive a wiper blade. In the upward direction heat is transferred to the frame, from the frame through a gap in the wiper body carrying the blade and finally down to the blade. In the outward lateral direction, heat is transferred to the surrounding air and essentially wasted. This indirect heating method is accordingly inefficient, and limits the flexibility of the blade, thereby inhibiting the blade wiping action.

None of these patents teach a heated wiper arm system and carrier of simple, economical construction wherein the wiper arm assembly and carrier can be both easily constructed and easily installed on an existing wiper arm. Also no one has a heated wiper arm or heated wiper arm system.

Accordingly, it is an object of the present invention to provide a simple, low cost wiper arm system and carrier heating arrangement, which is capable of removing and/or preventing ice or snow build-up. It is a further object of this invention to provide a flexible heating arrangement suitable for incorporation a into new or existing wiper arms carrier, and associated assemblies; which is not fatigued by the repeated stresses of reciprocation; easy to replace and install; able to adapt to use on windshields having most any lateral or longitudinal curvature.

It is yet a further object of this invention to provide a heated wiper arm system and carrier heating arrangement, which permits the wiper arm to conform to the shape of the windshield under snow, sleet and all other conditions. Thus providing satisfactory wiping performance while simultaneously removing and keeping the wiper arm, carrier, linkage, and other associated components free from interference by ice, snow.

Another object is to provide a heated wiper arm and carrier heating arrangement, which allows for each 12 Volt arm to be calibrated so as eliminating complexity, multiple connectors, timer, thermostat, and resistors by designing the heating wire to serve as the heating element and resistor.

It is to be understood that this invention is not limited in its application to the details of construction and to the following description or illustrations in the drawings. This invention is capable of other embodiments and of being practiced and carried out in various ways, also. It is to be understood that the phraseology and terminology employed herein are for the purpose of description and should not be regarded as limiting.

### SUMMARY OF INVENTION

The principle object of the present invention is to provide a new heated windshield wiper arm system, the assembly construction wherein the same can be utilized for clearing and removing ice formation on the arm. As such, the general purpose of the present invention, which will be described subsequently in greater detail, is to provide a unique apparatus which has many advantages of the heated wiper arm system mentioned heretofore and many novel features that result in a heated windshield wiper arm which is not anticipated, rendered obvious, suggested or even implied by any of the prior art wipers, either alone or in any combination thereof.

To attain this, the present invention comprises a heated wiper arm system formed of heat resistant material, which includes a hollow horizontal passageway extending the entire length of the wiper arm. A heating element of any appropriate configuration, such as a helical or corrugate, is positioned through the entire length of the passageway of the wiper arm under body. A protective flexible, air tight, moisture and heat resistant end insulator sleeve, or the like, containing the extended heating element and is inserted into or onto first and second passageway ends and sealed with a moisture impervious material.

Said extended heating element first end continues upward within the tubular carrier where it is joined with the second end of the live lead hot wire such as insulated stranded copper wire, using any know method, such as, crimp connection, solder, or the like. The ground wire first end is connected to the second end of heating element end and likewise joined.

Electric power is supplied to the heating element utilizing the vehicles existing power supply in any currently known manner using a 12 Volt system without the necessity of additional resistors. The circuitry, basically an electrical source with a fuse is connected to the heating element. The heating element also connects to a ground source. Simply stated current passes through the heating element and the heat is conducted into the under body of the arm, end insulator sleeves and carrier, thus heating the entire surface of the arm body, carrier and surrounding end area.

Field testing of this invention has proven successful in providing satisfactory wiping Performance while simultaneously removing and keeping the windshield, wiper under body arm, carrier and associated components free from interference by ice, sleet, with no apparent deterioration of the wiper arm or blade, wiping performance, heating element or other embodiments.

The present invention may be easily and efficiently manufactured utilizing heat wire, thermostat, shrink tubing, control box.

### BRIEF DESCRIPTION OF THE DRAWINGS

This invention will be better understood and objects other than those set forth above will become apparent when consideration is given to the following detailed description thereof. Such description makes reference to the annexed drawings wherein:

FIG. 1 is an enlarged sectional end view of the Heated wiper arm system with its contents.

FIG. 2 is an enlarged front view and rear view of the Control Unit.

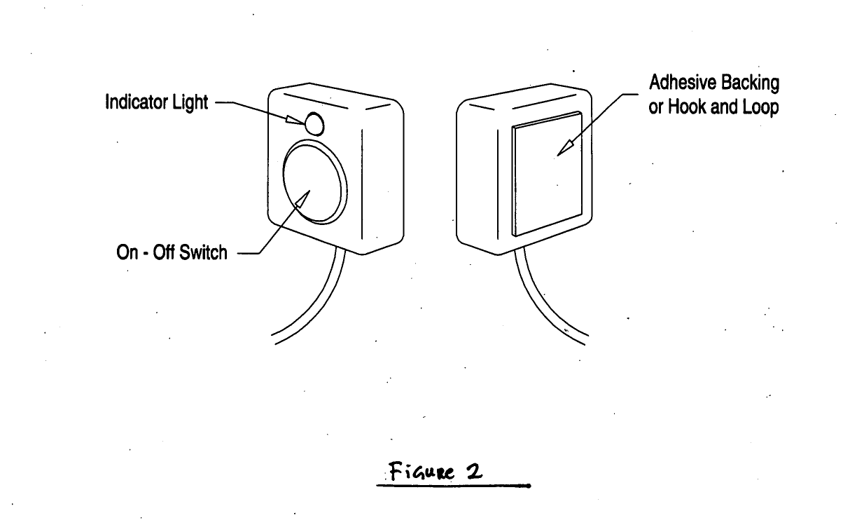

FIG. 3 is an enlarged longitudinal sectional view of the Heated Wiper Arm System illustrating the heating element within the passageway and extending outwardly.

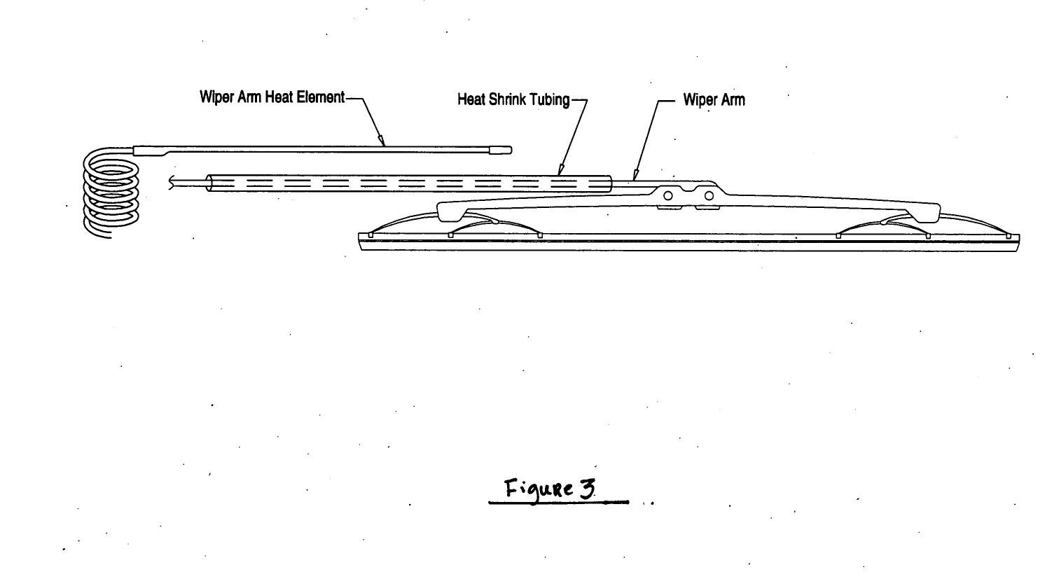

### DETAILED DESCRIPTION OF THE DRAWINGS

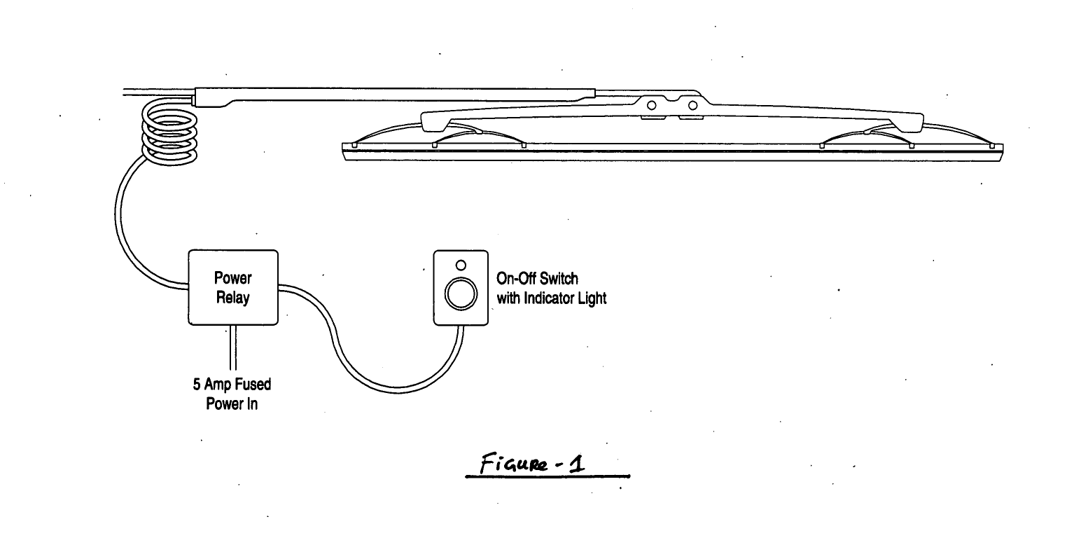

Referring now more specifically to the drawings, FIG. 1 shows the heated wiper system inserted through heat shrink on the under body of the arm. Current in a live lead wire first end leading from the vehicle electrical source of power, the battery (not shown) via ignition on-off switch (not shown) entering the control box then out to the heat wire to the sleeve on the arm enters first end of first insulator sleeve and connects to the first end. of heating element.

I claim:

1. A heated wiper arm assembly system adapted to be mounted to a wiper arm of a motor vehicle and adapted to be connected to a vehicle electrical system, said assembly comprising: an elongated, tubular arm carrier which defines first and said carrier includes shrink tube wire and thermostat thereon; an elongated, wiper arm system, said wiper arm system comprised of an elongated, flexible heated wire, shrink tubing and a thermostat and control box with a 12 volt power and ground system.
A first elongated, a heat shrink sleeve has a first end received into the under body arm passageway at the first end of the body and a second end received into the first hollow end of the carrier; an elongated, one piece heating element of resistance wire having first and second ends and being of helical form intermediate said ends, said heating element is loosely received in the passageway of said underbody arm with said first end thereof extending through the first heat shrink sleeve into the first end of the carrier and with said second end thereof extending through the second heat shrink sleeve into the second end of the carrier wherein said heating element heats both the heated wiper arm system and the elongated carrier/blade, said first end of said heating element is connected with a first lead wire within said first heat shrink sleeve within said first end of said carrier.
